(19) United States
(12) Patent Application Publication
(10) Pub. No.: US 2025/0026379 A1
(43) Pub. Date: Jan. 23, 2025

(54) TRAFFIC SIGN PREDICTION FOR A VEHICLE

(71) Applicant: GM Global Technology Operations LLC, Detroit, MI (US)

(72) Inventors: Md Mhafuzul Islam, Warren, MI (US); Alireza Esna Ashari Esfahani, Daly City, CA (US); Azeem Sarwar, Rochester Hills, MI (US)

(21) Appl. No.: 18/355,574

(22) Filed: Jul. 20, 2023

(51) Int. Cl. B60W 60/00; B60W 40/02; B60W 50/00; G06N 7/02

(52) U.S. Cl. CPC B60W 60/00274; B60W 40/02; B60W 50/0097; G06N 7/02; B60W 2554/4045; B60W 2555/20; B60W 2556/20; B60W 2556/45

(57) ABSTRACT

A method for traffic sign prediction includes determining a plurality of roadway characteristics. The method also includes determining a plurality of road user information. The method also includes determining a plurality of weather-related information. The method also includes determining a predicted traffic sign based at least in part on the plurality of roadway characteristics, the plurality of road user information, and the plurality of weather-related information. The method also includes performing an action based at least in part on the predicted traffic sign.

The present disclosure relates to advanced driver assistance and automated driving systems and methods for vehicles, and more particularly, to systems and methods for traffic sign prediction for a vehicle.

To increase occupant awareness and convenience, vehicles may be equipped with advanced driver assistance systems (ADAS) and/or automated driving systems (ADS). ADAS systems may use various sensors such as cameras, radar, and LiDAR (laser imaging, detection, and ranging) to detect and identify objects around the vehicle, including other vehicles, pedestrians, road configurations, and traffic signs. ADS systems may take actions based on environmental conditions surrounding the vehicle, such as controlling the vehicle to navigate the vehicle through the environment towards a destination. However, the performance of current ADS systems may be impacted by recognition and interpretation of traffic signs. For example, in some instances, traffic signs may be missing, outdated, or otherwise invalid or inapplicable. In other instances, traffic signs may be obstructed or occluded by weather conditions or the like, hindering accurate identification and/or recognition.

Thus, while ADAS and ADS systems and methods achieve their intended purpose, there is a need for a new and improved system and method for traffic sign prediction for a vehicle.

### SUMMARY

According to several aspects, a method for traffic sign prediction is provided. The method includes determining a plurality of roadway characteristics. The method also includes determining a plurality of road user information. The method also includes determining a plurality of weather-related information. The method also includes determining a predicted traffic sign based at least in part on the plurality of roadway characteristics, the plurality of road user information, and the plurality of weather-related information. The method also includes performing an action based at least in part on the predicted traffic sign.

In another aspect of the present disclosure, determining the plurality of roadway characteristics further may include determining the plurality of roadway characteristics using at least one of a perception sensor and data retrieved from a remote server. The plurality of roadway characteristics includes at least one roadway geometry characteristic, at least one roadway condition characteristic, and at least one roadside environment characteristic.

In another aspect of the present disclosure, determining the plurality of road user information further may include detecting a plurality of road users. Determining the plurality of road user information further may include detecting a plurality of roadside users. Determining the plurality of road user information further may include determining a plurality of predicted paths of each of the plurality of road users and the plurality of roadside users. Determining the plurality of road user information further may include determining the plurality of road user information. The plurality of road user information includes at least a quantity of the plurality of road users, a quantity of the plurality of roadside users, and the plurality of predicted paths.

In another aspect of the present disclosure, determining the plurality of weather-related information further may include determining the plurality of weather-related information using at least one of a perception sensor and data retrieved from a remote server. The plurality of weather-related information includes at least one precipitation weather condition and at least one visibility weather condition.

In another aspect of the present disclosure, determining the predicted traffic sign further may include determining the predicted traffic sign using a rule-based algorithm. The rule-based algorithm takes the plurality of roadway characteristics, the plurality of road user information, and the plurality of weather-related information as inputs and produces the predicted traffic sign as output.

In another aspect of the present disclosure, determining the predicted traffic sign further may include determining the predicted traffic sign using a fuzzy logic algorithm. The fuzzy logic algorithm takes the plurality of roadway characteristics, the plurality of road user information, and the plurality of weather-related information as inputs and produces a plurality of possible predicted traffic signs and a corresponding plurality of confidence values as output. Determining the predicted traffic sign further may include determining the predicted traffic sign to be one of the plurality of possible predicted traffic signs based at least in part on the corresponding plurality of confidence values.

In another aspect of the present disclosure, determining the predicted traffic sign further may include determining the predicted traffic sign using a machine learning algorithm. The machine learning algorithm takes the plurality of roadway characteristics, the plurality of road user information, and the plurality of weather-related information as inputs and produces a plurality of possible predicted traffic signs and a corresponding plurality of confidence values as output. Determining the predicted traffic sign further may include determining the predicted traffic sign to be one of the plurality of possible predicted traffic signs based at least in part on the corresponding plurality of confidence values.

In another aspect of the present disclosure, determining the predicted traffic sign further may include validating the predicted traffic sign using a predetermined ruleset.

In another aspect of the present disclosure, validating the predicted traffic sign further may include evaluating the predicted traffic sign with the predetermined ruleset; modifying the predicted traffic sign in response to determining that the predicted traffic sign is contrary to the predetermined ruleset.

In another aspect of the present disclosure, performing the action based at least in part on the predicted traffic sign further may include transmitting the predicted traffic sign to at least one of a remote vehicle and a remote server. Performing the action based at least in part on the predicted traffic sign further may include adjusting a path planning and control algorithm of an automated driving system based at least in part on the predicted traffic sign.

According to several aspects, a system for traffic sign prediction for a vehicle is provided. The system includes a plurality of vehicle sensors. The system also includes a controller in electrical communication with the plurality of vehicle sensors. The controller is programmed to determine a plurality of roadway characteristics using at least one of the plurality of vehicle sensors. The controller is further programmed to determine a plurality of road user information using at least one of the plurality of vehicle sensors. The controller is further programmed to determine a plurality of weather-related information using at least one of the plurality of vehicle sensors. The controller is further programmed to determine a predicted traffic sign based at least in part on the plurality of roadway characteristics, the plurality of road user information, and the plurality of weather-related information. The controller is further programmed to perform an action based at least in part on the predicted traffic sign.

In another aspect of the present disclosure, the plurality of vehicle sensors further includes at least one perception sensor. To determine the plurality of roadway characteristics, the controller is further programmed to perform a plurality of measurements of an environment surrounding the vehicle using the at least one perception sensor. To determine the plurality of roadway characteristics, the controller is further programmed to determine the plurality of roadway characteristics based at least in part on the plurality of measurements. The plurality of roadway characteristics includes at least one roadway geometry characteristic, at least one roadway condition characteristic, and at least one roadside environment characteristic.

In another aspect of the present disclosure, the plurality of vehicle sensors further includes a vehicle communication system. To determine the plurality of roadway characteristics, the controller is further programmed to receive at least one of a V2V message and a V2X message including the plurality of roadway characteristics using the vehicle communication system. The plurality of roadway characteristics includes at least one roadway geometry characteristic, at least one roadway condition characteristic, and at least one roadside environment characteristic.

In another aspect of the present disclosure, to determine the plurality of road user information, the controller is further programmed to detect a plurality of road users using the plurality of vehicle sensors. To determine the plurality of road user information, the controller is further programmed to detect a plurality of roadside users using the plurality of vehicle sensors. To determine the plurality of road user information, the controller is further programmed to determine a plurality of predicted paths of each of the plurality of road users and the plurality of roadside users. To determine the plurality of road user information, the controller is further programmed to determine the plurality of road user information. The plurality of road user information includes at least a quantity of the plurality of road users, a quantity of the plurality of roadside users, and the plurality of predicted paths.

In another aspect of the present disclosure, the plurality of vehicle sensors further includes at least one of a perception sensor and a vehicle communication system. To determine the plurality of weather-related information, the controller is further programmed to determine the plurality of weather-related information using at least one of the perception sensor and the vehicle communication system. The plurality of weather-related information includes at least one precipitation weather condition and at least one visibility weather condition.

In another aspect of the present disclosure, to determine the predicted traffic sign, the controller is further programmed to determine the predicted traffic sign using a prediction algorithm. The prediction algorithm takes the plurality of roadway characteristics, the plurality of road user information, and the plurality of weather-related information as inputs and produces a plurality of possible predicted traffic signs and a corresponding plurality of confidence values as output. The prediction algorithm is at least one of a rule-based algorithm, a fuzzy logic algorithm, and a machine learning algorithm. To determine the predicted traffic sign, the controller is further programmed to determine the predicted traffic sign to be one of the plurality of possible predicted traffic signs based at least in part on the corresponding plurality of confidence values. To determine the predicted traffic sign, the controller is further programmed to validate the predicted traffic sign by evaluating the predicted traffic sign with a predetermined ruleset. To determine the predicted traffic sign, the controller is further programmed to modify the predicted traffic sign in response to determining that the predicted traffic sign is contrary to the predetermined ruleset.

In another aspect of the present disclosure, the system further comprises an automated driving system in electrical communication with the controller. The plurality of vehicle sensors further includes a vehicle communication system. To perform the action, the controller is further programmed to transmit the predicted traffic sign to at least one of a remote vehicle and a remote server using the vehicle communication system. To perform the action, the controller is further programmed to adjust a path planning and control algorithm of the automated driving system based at least in part on the predicted traffic sign.

According to several aspects, a system for traffic sign prediction for a vehicle is provided. The system includes a plurality of vehicle sensors. The plurality of vehicle sensors includes at least one perception sensor. The plurality of vehicle sensors further includes at least a vehicle communication system. The system also includes an automated driving system. The system also includes a controller in electrical communication with the plurality of vehicle sensors and the automated driving system. The controller is programmed to determine a plurality of roadway characteristics using at least one of the plurality of vehicle sensors. The plurality of roadway characteristics includes at least one roadway geometry characteristic, at least one roadway condition characteristic, and at least one roadside environment characteristic. The controller is further programmed to determine a plurality of road user information using at least one of the plurality of vehicle sensors. The controller is further programmed to determine a plurality of weather-related information using at least one of the plurality of vehicle sensors. The plurality of weather-related information includes at least one precipitation weather condition and at least one visibility weather condition. The controller is further programmed to determine a predicted traffic sign based at least in part on the plurality of roadway characteristics, the plurality of road user information, and the plurality of weather-related information. The controller is further programmed to transmit the predicted traffic sign to at least one of a remote vehicle and a remote server using the vehicle communication system. The controller is further programmed to adjust a path planning and control algorithm of the automated driving system based at least in part on the predicted traffic sign.

In another aspect of the present disclosure, to determine the plurality of road user information, the controller is further programmed to detect a plurality of road users using the plurality of vehicle sensors. To determine the plurality of road user information, the controller is further programmed to detect a plurality of roadside users using the plurality of vehicle sensors. To determine the plurality of road user information, the controller is further programmed to determine a plurality of predicted paths of each of the plurality of road users and the plurality of roadside users. To determine the plurality of road user information, the controller is further programmed to determine the plurality of road user information. The plurality of road user information includes at least a quantity of the plurality of road users, a quantity of the plurality of roadside users, and the plurality of predicted paths.

In another aspect of the present disclosure, to determine the predicted traffic sign, the controller is further programmed to determine the predicted traffic sign using a prediction algorithm. The prediction algorithm takes the plurality of roadway characteristics, the plurality of road user information, and the plurality of weather-related information as inputs and produces a plurality of possible predicted traffic signs and a corresponding plurality of confidence values as output. The prediction algorithm is at least one of a rule-based algorithm, a fuzzy logic algorithm, and a machine learning algorithm. To determine the predicted traffic sign, the controller is further programmed to determine the predicted traffic sign to be one of the plurality of possible predicted traffic signs based at least in part on the corresponding plurality of confidence values. To determine the predicted traffic sign, the controller is further programmed to validate the predicted traffic sign by evaluating the predicted traffic sign with a predetermined ruleset. To determine the predicted traffic sign, the controller is further programmed to modify the predicted traffic sign in response to determining that the predicted traffic sign is contrary to the predetermined ruleset.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for traffic sign prediction for a vehicle, according to an exemplary embodiment; and

FIG. 2 is a flowchart of a method for traffic sign prediction for a vehicle, according to an exemplary embodiment.

### DETAILED DESCRIPTION

The following description is merely exemplary in nature and is not intended to limit the present disclosure, application, or uses.

Identification and recognition of traffic signs may be important for accurate operation of automated driving systems. In some cases, traffic signs may be missing or obstructed. In other cases, dynamic road conditions such as, for example, road construction, weather conditions, traffic volume, and/or the like may render posted traffic signs invalid and/or irrelevant. Accordingly, the present disclosure provides a new and improved system and method for traffic sign prediction for a vehicle, allowing for prediction of traffic signs in situations when actual traffic signs are missing, obstructed, or otherwise unreadable.

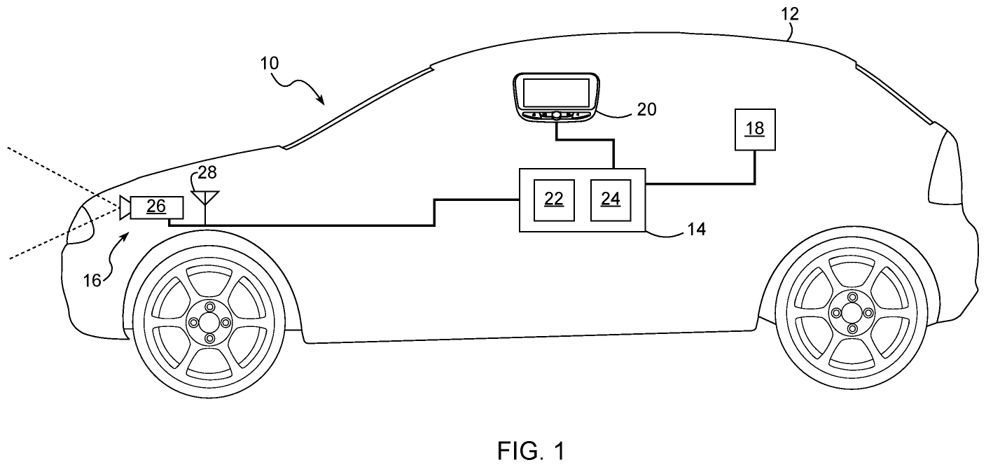

Referring to FIG. 1, a system for traffic sign prediction for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, a plurality of vehicle sensors 16, an automated driving system 18, and a display 20.

The controller 14 is used to implement a method 100 for traffic sign prediction, as will be described below. The controller 14 includes at least one processor 22 and a non-transitory computer readable storage device or media 24. The processor 22 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions. The computer readable storage device or media 24 may include volatile and nonvolatile storage in read-only memory (ROM), random-access memory (RAM), and keep-alive memory (KAM), for example. KAM is a persistent or non-volatile memory that may be used to store various operating variables while the processor 22 is powered down. The computer-readable storage device or media 24 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12. The controller 14 may also consist of multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the plurality of vehicle sensors 16, the automated driving system 18, and the display 20. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure.

The plurality of vehicle sensors 16 are used to acquire information about an environment surrounding the vehicle 12. In an exemplary embodiment, the plurality of vehicle sensors 16 includes at least a camera system 26 (i.e., a perception sensor) and a vehicle communication system 28.

In another exemplary embodiment, the plurality of vehicle sensors 16 further includes sensors to determine performance data about the vehicle 12. In a non-limiting example, the plurality of vehicle sensors 16 further includes at least one of a motor speed sensor, a motor torque sensor, an electric drive motor voltage and/or current sensor, an accelerator pedal position sensor, a brake position sensor, a coolant temperature sensor, a cooling fan speed sensor, and a transmission oil temperature sensor.

In another exemplary embodiment, the plurality of vehicle sensors 16 further includes sensors to determine information about the environment within the vehicle 12. In a non-limiting example, the plurality of vehicle sensors 16 further includes at least one of a seat occupancy sensor, a cabin air temperature sensor, a cabin motion detection sensor, a cabin camera, a cabin microphone, and/or the like.

In another exemplary embodiment, the plurality of vehicle sensors 16 further includes sensors to determine information about the environment surrounding the vehicle 12. In a non-limiting example, the plurality of vehicle sensors 16 further includes at least one of an ambient air temperature sensor, a barometric pressure sensor, a global navigation satellite system (GNSS), and/or a photo and/or video camera which is positioned to view the environment in front of the vehicle 12.

In another exemplary embodiment, at least one of the plurality of vehicle sensors 16 is a perception sensor capable of measuring distances in the environment surrounding the vehicle 12. In a non-limiting example, the plurality of vehicle sensors 16 includes a stereoscopic camera having distance measurement capabilities. In one example, at least one of the plurality of vehicle sensors 16 is affixed inside of the vehicle 12, for example, in a headliner of the vehicle 12, having a view through a windscreen of the vehicle 12. In another example, at least one of the plurality of vehicle sensors 16 is affixed outside of the vehicle 12, for example, on a roof of the vehicle 12, having a view of the environment surrounding the vehicle 12. It should be understood that various additional types of vehicle sensors, such as, for example, LiDAR sensors, ultrasonic ranging sensors, radar sensors, time-of-flight sensors, and/or other types of perception sensors are within the scope of the present disclosure. The plurality of vehicle sensors 16 are in electrical communication with the controller 14 as discussed above.

The camera system 26 is a perception sensor used to capture images and/or videos of the environment surrounding the vehicle 12. In an exemplary embodiment, the camera system 26 includes a photo and/or video camera which is positioned to view the environment surrounding the vehicle 12. In a non-limiting example, the camera system 26 includes a camera affixed inside of the vehicle 12, for example, in a headliner of the vehicle 12, having a view through a windscreen. In another non-limiting example, the camera system 26 includes a camera affixed outside of the vehicle 12, for example, on a roof of the vehicle 12, having a view of the environment in front of the vehicle 12.

In another exemplary embodiment, the camera system 26 is a surround view camera system including a plurality of cameras (also known as satellite cameras) arranged to provide a view of the environment adjacent to all sides of the vehicle 12. In a non-limiting example, the camera system 26 includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the camera system 26 further includes an additional rear-view camera mounted near a center high mounted stop lamp of the vehicle 12.

It should be understood that camera systems having additional cameras and/or additional mounting locations are within the scope of the present disclosure. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The vehicle communication system 28 is used by the controller 14 to communicate with other systems external to the vehicle 12. For example, the vehicle communication system 28 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems). In certain embodiments, the vehicle communication system 28 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 28 may further include an embedded universal integrated circuit card (eUICC) configured to store at least one cellular connectivity configuration profile, for example, an embedded subscriber identity module (eSIM) profile. The vehicle communication system 28 is further configured to communicate via a personal area network (e.g., BLUETOOTH) and/or near-field communication (NFC). However, additional or alternate communication methods, such as a dedicated short-range communications (DSRC) channel and/or mobile telecommunications protocols based on the 3^{rd} Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure. Accordingly, the vehicle communication system 28 may include one or more antennas and/or communication transceivers for receiving and/or transmitting signals, such as cooperative sensing messages (CSMs). The vehicle communication system 28 is configured to wirelessly communicate information between the vehicle 12 and another vehicle. Further, the vehicle communication system 28 is configured to wirelessly communicate information between the vehicle 12 and infrastructure or other vehicles. It should be understood that the vehicle communication system 28 may be integrated with the controller 14 (e.g., on a same circuit board with the controller 14 or otherwise a part of the controller 14) without departing from the scope of the present disclosure.

The automated driving system 18 is used to provide assistance to an occupant to increase occupant awareness and/or control behavior of the vehicle 12. In the scope of the present disclosure, the occupant includes a driver and/or a passenger of the vehicle 12. In the scope of the present disclosure, the automated driving system 18 encompasses systems which provide any level of assistance to the occupant (e.g., blind spot warning, lane departure warning, and/or the like) and systems which are capable of autonomously driving the vehicle 12 under some or all conditions. It should be understood that all levels of driving automation defined by, for example, SAE J3016 (i.e., SAE LEVEL 0, SAE LEVEL 1, SAE LEVEL 2, SAE LEVEL 3, SAE LEVEL 4, and SAE LEVEL 5) are within the scope of the present disclosure.

In an exemplary embodiment, the automated driving system 18 is configured to detect and/or receive information about the environment surrounding the vehicle 12 and process the information to provide assistance to the occupant. In some embodiments, the automated driving system 18 is a software module executed on the controller 14. In other embodiments, the automated driving system 18 includes a separate automated driving system controller, similar to the controller 14, capable of processing the information about the environment surrounding the vehicle 12. In an exemplary embodiment, the automated driving system 18 may operate in a manual operation mode, a partially automated operation mode, and/or a fully automated operation mode.

In the scope of the present disclosure, the manual operation mode means that the automated driving system 18 provides warnings or notifications to the occupant but does not intervene or control the vehicle 12 directly. In a non-limiting example, the automated driving system 18 receives information from the plurality of vehicle sensors 16. Using techniques such as, for example, computer vision, the automated driving system 18 understands the environment surrounding the vehicle 12 and provides assistance to the occupant. For example, if the automated driving system 18 identifies, based on data from the plurality of vehicle sensors 16, that the vehicle 12 is likely to collide with a remote vehicle, the automated driving system 18 may use the display 20 to provide a warning to the occupant.

In the scope of the present disclosure, the partially automated operation mode means that the automated driving system 18 provides warnings or notifications to the occupant and may intervene or control the vehicle 12 directly in certain situations. In a non-limiting example, the automated driving system 18 is additionally in electrical communication with components of the vehicle 12 such as a brake system, a propulsion system, and/or a steering system of the vehicle 12, such that the automated driving system 18 may control the behavior of the vehicle 12. In a non-limiting example, the automated driving system 18 may control the behavior of the vehicle 12 by applying brakes of the vehicle 12 to avoid an imminent collision. In another non-limiting example, the automated driving system 18 may control the brake system, propulsion system, and steering system of the vehicle 12 to temporarily drive the vehicle 12 towards a predetermined destination. However, intervention by the occupant may be required at any time. In an exemplary embodiment, the automated driving system 18 may include additional components such as, for example, an eye tracking device configured to monitor an attention level of the occupant and ensure that the occupant is prepared to take over control of the vehicle 12.

In the scope of the present disclosure, the fully automated operation mode means that the automated driving system 18 uses data from the plurality of vehicle sensors 16 to understand the environment and control the vehicle 12 to drive the vehicle 12 towards a predetermined destination without a need for control or intervention by the occupant.

The automated driving system 18 operates using a path planning and control algorithm which is configured to generate a safe and efficient trajectory for the vehicle 12 to navigate in the environment surrounding the vehicle 12. In an exemplary embodiment, the path planning and control algorithm is a machine learning algorithm trained to output control signals for the vehicle 12 based on input data collected from the plurality of vehicle sensors 16. In another exemplary embodiment, the path planning and control algorithm is a deterministic algorithm which has been programmed to output control signals for the vehicle 12 based on data collected from the plurality of vehicle sensors 16.

In a non-limiting example, the path planning and control algorithm performs perception and mapping tasks to interpret data collected from the plurality of vehicle sensors 16 and create a detailed map of the environment. The detailed map may include information about lane boundaries, road geometry, speed limits, traffic signs, and/or other relevant features. Based on the detailed map and a current state of the vehicle 12 (i.e., position, velocity, and orientation of the vehicle 12, the path planning and control algorithm generates a sequence of waypoints or a continuous path that the vehicle 12 should follow to reach a destination while adhering to rules, regulations, and safety constraints. It should be understood that the automated driving system 18 may include any software and/or hardware module configured to operate in the manual operation mode, the partially automated operation mode, or the fully automated operation mode as described above.

The display 20 is used to provide information to the occupant of the vehicle 12. In the exemplary embodiment depicted in FIG. 1, the display 20 is a human-machine interface (HMI) located in view of the occupant and capable of displaying text, graphics and/or images. It is to be understood that HMI display systems including LCD displays, LED displays, and the like are within the scope of the present disclosure. Further exemplary embodiments where the display 20 is disposed in a rearview mirror are also within the scope of the present disclosure. In another exemplary embodiment, the display 20 includes a head-up display (HUD) configured to provide information to the occupant by projecting text, graphics, and/or images upon the windscreen of the vehicle 12. The text, graphics, and/or images are reflected by the windscreen of the vehicle 12 and are visible to the occupant without looking away from a roadway ahead of the vehicle 12. In another exemplary embodiment, the display 20 includes an augmented reality head-up display (AR-HUD). The AR-HUD is a type of HUD configured to augment the occupant's vision of the roadway ahead of the vehicle 12 by overlaying text, graphics, and/or images on physical objects in the environment surrounding the vehicle 12 within a field-of-view of the occupant. In an exemplary embodiment, the occupant may interact with the display 20 using a human-interface device (HID), including, for example, a touchscreen, an electromechanical switch, a capacitive switch, a rotary knob, and the like. It should be understood that additional systems for displaying information to the occupant of the vehicle 12 are also within the scope of the present disclosure.

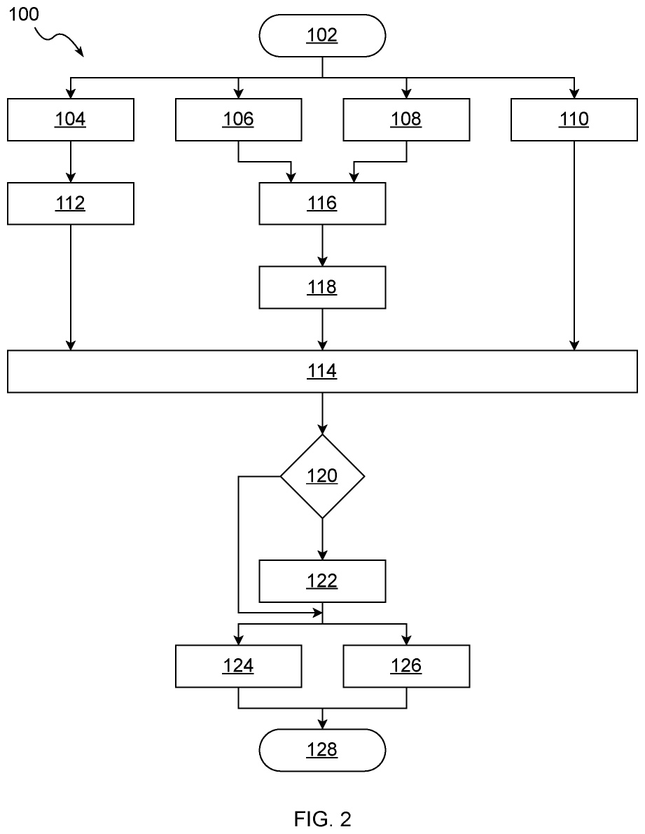

Referring to FIG. 2, a flowchart of the method 100 for traffic sign prediction is shown. The method 100 begins at block 102 and proceeds to blocks 104, 106, 108, and 110.

At block 104, the controller 14 performs a plurality of measurements of an environment surrounding the vehicle 12 using the plurality of vehicle sensors 16. In an exemplary embodiment, the plurality of measurements is performed using a perception sensor of the plurality of vehicle sensors 16, for example, the camera system 26, a LIDAR system, a radar system, and/or the like. In a non-limiting example, the plurality of measurements includes distance measurements from the vehicle 12 to a plurality of points in the environment surrounding the vehicle 12. In another non-limiting example, the plurality of measurements includes images and/or videos of the environment surrounding the vehicle 12 captured by the camera system 26. In another non-limiting example, the plurality of measurements includes data about the environment surrounding the vehicle 12 received using the vehicle communication system 28. For example, the controller 14 may use the vehicle communication system 28 to transmit a location of the vehicle 12 (as determined using the GNSS) to a remote server. The remote server may respond by transmitting information about the environment surrounding the vehicle 12 to the vehicle communication system 28 (e.g., using at least one of a V2V message and/or a V2X message), including, for example, information about roadway geometry, roadway condition, and/or roadside environment of the environment surrounding the vehicle 12. After block 104, the method 100 proceeds to block 112.

At block 112, the controller 14 determines a plurality of roadway characteristics based at least in part on the plurality of measurements performed at block 104. In the scope of the present disclosure, the plurality of roadway characteristics are characteristics of a roadway in the environment surrounding the vehicle. In an exemplary embodiment, the plurality of roadway characteristics includes at least one roadway geometry characteristic (i.e., characteristics of a geometry of the roadway), at least one roadway condition characteristic (i.e., characteristics of a surface condition of the roadway), and at least one roadside environment characteristic (i.e., characteristics of an environmental context of the roadway). In a non-limiting example, the at least one roadway geometry characteristic includes, for example, a lane width, a horizontal curve radius, a sight distance, a vertical curve radius, a vertical elevation, presence of an intersection, and/or the like. In a non-limiting example, the at least one roadway condition characteristic includes, for example, a pavement condition of the roadway. In a non-limiting example, the at least one roadside environment characteristic includes, for example, road function (e.g., urban, rural, highway), presence of driveways along the roadway, presence of roadside developments (e.g., commercial buildings and/or residential buildings), a shoulder width, a shoulder pavement condition, presence of pedestrian infrastructure along the roadway (e.g., sidewalks) and/or the like. After block 112, the method 100 proceeds to block 114, as will be discussed in greater detail below.

At block 106, the controller 14 detects a plurality of road users. In the scope of the present disclosure, the plurality of road users are users of the roadway besides the vehicle 12, for example, remote vehicles, construction workers, pedestrians, cyclists, wildlife, and/or the like. In an exemplary embodiment, the controller 14 uses one or more of the plurality of vehicle sensors 16 to detect the plurality of road users. In a non-limiting example, the controller 14 uses the vehicle communication system 28 to receive V2V and/or V2X messages from remote vehicles and/or infrastructure. The V2V and/or V2X messages include information about one or more of the plurality of road users, for example, a location, speed, and heading of a remote vehicle on the roadway. In another non-limiting example, the controller 14 uses the camera system 26 to capture a plurality of images of the environment surrounding the vehicle 12 and a computer vision algorithm to analyze the plurality of images and identify the plurality of road users. In yet another non-limiting example, the controller 14 uses another type of perception sensor, such as, for example, a LIDAR sensor, a radar sensor, and/or the like, to perform a plurality of measurements of the environment surrounding the vehicle 12 and identify the plurality of road users. After block 106, the method 100 proceeds to block 116, as will be discussed in greater detail below.

At block 108, the controller 14 detects a plurality of roadside users. In the scope of the present disclosure, the plurality of roadside users are users of the environment surrounding the roadway (i.e., the roadside). The plurality of roadside may include, for example, pedestrians, cyclists, and animals on a sidewalk and/or shoulder of the roadway, stopped/parked vehicles on the shoulder of the roadway, and/or the like. In an exemplary embodiment, the controller 14 uses one or more of the plurality of vehicle sensors 16 to detect the plurality of roadside users. In a non-limiting example, the controller 14 uses the vehicle communication system 28 to receive V2V and/or V2X messages from remote vehicles and/or infrastructure. The V2V and/or V2X messages include information about one or more of the plurality of roadside users, for example, a location of a parked remote vehicle on the roadside. In another non-limiting example, the controller 14 uses the camera system 26 to capture a plurality of images of the environment surrounding the vehicle 12 and a computer vision algorithm to analyze the plurality of images and identify the plurality of roadside users. In yet another non-limiting example, the controller 14 uses another type of perception sensor, such as, for example, a LIDAR sensor, a radar sensor, and/or the like, to perform a plurality of measurements of the environment surrounding the vehicle 12 and identify the plurality of roadside users. After block 108, the method 100 proceeds to block 116, as will be discussed in greater detail below.

At block 116, the controller 14 determines a plurality of predicted paths of each of the plurality of road users and the plurality of roadside users identified at blocks 108 and 108. In an exemplary embodiment, the plurality of predicted paths are determined using a statistical algorithm, such as, for example, a Kalman filter algorithm. The Kalman filter algorithm is a recursive algorithm which combines measurements from the plurality of vehicle sensors 16 with system dynamics to estimate the state of a dynamic system. In the context of path prediction, the Kalman filter takes into account measurements such as position, velocity, and acceleration to estimate current and future states of the plurality of road users and the plurality of roadside users.

In a non-limiting example, the Kalman filter algorithm operates in two main steps: prediction and update. During the prediction step, the Kalman filter algorithm uses a previous state estimate and a system dynamics model to project the expected state of the plurality of road users and the plurality of roadside users at the next time step. This prediction incorporates information about the plurality of road users and the plurality of roadside users such as, for example, velocity, acceleration, heading, and/or the like. In the update step, the Kalman filter algorithm combines the predicted state with real-time measurements from the plurality of vehicle sensors 16. By iteratively repeating the prediction and update steps, the Kalman filter algorithm continuously refines and predicts the future path of the plurality of road users and the plurality of roadside users. After block 116, the method 100 proceeds to block 118.

At block 118, the controller 14 determines a plurality of road user information based at least in part on the plurality of road users detected at block 106, the plurality of roadside users detected at block 108, and the plurality of predicted paths determined at block 116. In an exemplary embodiment, the plurality of road user information includes at least a quantity of road users (i.e., a number of remote vehicles, construction workers, pedestrians, cyclists, wildlife, and/or the like on the roadway), a quantity of roadside users (i.e., a number of pedestrians, cyclists, and animals on the sidewalk and/or shoulder of the roadway, stopped/parked vehicles on the shoulder of the roadway, and/or the like), and the plurality of predicted paths determined at block 116. In an exemplary embodiment, the plurality of road user information may include further details, such as, for example, a type of remote vehicle on the roadway/roadside (e.g., construction vehicle, emergency vehicle, semi-truck, and/or the like). Additionally, the plurality of road user information may be filtered based on relevance. For example, information pertaining to remote vehicles traveling on an opposite side of a divided highway from the vehicle 12 may not be relevant, and thus such information may be removed from the plurality of road user information. After block 118, the method 100 proceeds to block 114, as will be discussed in greater detail below.

At block 110, the controller 14 determines a plurality of weather-related information. In the scope of the present disclosure, the plurality of weather-related information is information about weather in the environment surrounding the vehicle 12. In an exemplary embodiment, the plurality of weather-related information includes at least one precipitation weather condition and at least one visibility weather condition. In a non-limiting example, the at least one precipitation weather condition includes, for example, a presence of rain, snow, sleet, hail, clear sky, and the like. The at least one visibility weather condition includes, for example, a presence and/or density of fog, a visibility distance, and/or the like. In an exemplary embodiment, to determine the plurality of weather related information, the controller 14 uses a perception sensor of the plurality of vehicle sensors 16 (e.g., the camera system 26) to capture an image of the environment surrounding the vehicle 12. The image is subsequently analyzed, using, for example, a computer vision algorithm, to determine the plurality of weather-related information. In another exemplary embodiment, the controller 14 uses the vehicle communication system 28 of the plurality of vehicle sensors 16 to retrieve data from a remote server (e.g., an internet application programming interface providing weather data), wherein the data includes the plurality of weather-related information. After block 110, the method 100 proceeds to block 114.

At block 114, the controller 14 determines a predicted traffic sign based at least in part on the plurality of roadway characteristics determined at block 112, the plurality of road user information determined at block 118, and the plurality of weather-related information determined at block 110. In the scope of the present disclosure, the predicted traffic sign is a traffic sign (e.g., stop sign, yield sign, speed limit sign, and/or the like) and/or traffic signal which is predicted to be applicable to the roadway conditions in the environment surrounding the vehicle 12. The predicted traffic sign is determined using a prediction algorithm.

In a first exemplary embodiment, the prediction algorithm is a rule-based algorithm. In the scope of the present disclosure, the rule-based algorithm is an algorithm which operates on a predefined set of rules and/or conditions to determine the predicted traffic sign. In a non-limiting example, the predefined set of rules is defined by standards, such as, for example, the Manual on Uniform Traffic Control Devices. In a non-limiting example, the rule-based algorithm is implemented using a lookup table (LUT) which maps the plurality of roadway characteristics determined at block 112, the plurality of road user information determined at block 118, and the plurality of weather-related information determined at block 110 to a predicted traffic sign.

The LUT has three key columns (i.e., one key column for each of the plurality of roadway characteristics, the plurality of road user information, and the plurality of weather-related information) and one value column (i.e., one value column for the predicted traffic sign). In an exemplary embodiment, the LUT includes a plurality of rows, each of the plurality of rows mapping a unique combination of the plurality of roadway characteristics, the plurality of road user information, and the plurality of weather-related information in the three key columns to a value in the value column (i.e., a predicted traffic sign). The LUT is stored in the media 24 of the controller 14. In an exemplary embodiment, the plurality of rows of the LUT are predetermined. In another exemplary embodiment, the plurality of rows of the LUT may be modified by the occupant, using, for example, a human-interface device. In yet another exemplary embodiment, the plurality of rows of the LUT may be updated over-the-air (OTA) using the vehicle communication system 28. It should be understood that any rule-based algorithm (e.g., programmatic data structure, logic equation, mathematical function, and/or the like) is within the scope of the present disclosure.

In a second exemplary embodiment, the prediction algorithm is a fuzzy logic algorithm. In the scope of the present disclosure, the fuzzy logic algorithm is an extension of classical (Boolean) logic that allows for the representation and manipulation of partial truth or degrees of membership. For example, in fuzzy logic, instead of strictly true or false values, variables may take on degrees of truth between 0 and 1, where 0 represents absolute falsehood, 1 represents absolute truth, and values in between represent different degrees of truth. In a non-limiting example, the fuzzy logic algorithm takes the plurality of roadway characteristics determined at block 112, the plurality of road user information determined at block 118, and the plurality of weather-related information determined at block 110 as inputs and produces a plurality of possible predicted traffic signs and a plurality of confidence values as outputs. Each of the plurality of confidence values corresponds to one of the plurality of possible predicted traffic signs. The predicted traffic sign is selected from the plurality of possible predicted traffic signs based at least in part on the plurality of confidence values. In a non-limiting example, one of the plurality of possible predicted traffic signs having a highest confidence value is determined to be the predicted traffic sign.

In a third exemplary embodiment, the prediction algorithm is a machine learning algorithm. In a non-limiting example, the machine learning algorithm takes the plurality of roadway characteristics determined at block 112, the plurality of road user information determined at block 118, and the plurality of weather-related information determined at block 110 as inputs and produces a plurality of possible predicted traffic signs and a plurality of confidence values as outputs. Each of the plurality of confidence values corresponds to one of the plurality of possible predicted traffic signs. The predicted traffic sign is selected from the plurality of possible predicted traffic signs based at least in part on the plurality of confidence values. In a non-limiting example, one of the plurality of possible predicted traffic signs having a highest confidence value is determined to be the predicted traffic sign.

In a non-limiting example, the machine learning algorithm is a deep neural network with multiple layers, including an input layer and an output layer, as well as one or more hidden layers. The input layer receives the plurality of roadway characteristics determined at block 112, the plurality of road user information determined at block 118, and the plurality of weather-related information determined at block 110 as inputs. The inputs are then passed on to the hidden layers. Each hidden layer applies a transformation (e.g., a non-linear transformation) to the data and passes the result to the next hidden layer until the final hidden layer. The output layer produces the plurality of possible predicted traffic signs and the plurality of confidence values.

To train the machine learning algorithm, a dataset of inputs their corresponding traffic signs is used. The algorithm is trained by adjusting internal weights between nodes in each hidden layer to minimize prediction error. During training, an optimization technique (e.g., gradient descent) is used to adjust the internal weights to reduce the prediction error. The training process is repeated with the entire dataset until the prediction error is minimized, and the resulting trained model is then used to predict traffic signs based on new input data.

After sufficient training of the machine learning algorithm, the algorithm is capable of accurately and precisely predicting traffic signs based on the plurality of roadway characteristics determined at block 112, the plurality of road user information determined at block 118, and the plurality of weather-related information determined at block 110. By adjusting the weights between the nodes in each hidden layer during training, the algorithm “learns” to recognize patterns in the data that are indicative of different traffic signs.

It should be understood that the prediction algorithm may include any method of abductive reasoning to determine the predicted traffic sign based at least in part on the plurality of roadway characteristics determined at block 112, the plurality of road user information determined at block 118, and the plurality of weather-related information determined at block 110 is within the scope of the present disclosure. After block 114, the method 100 proceeds to block 120.

At block 120, the controller 14 validates the predicted traffic sign determined at block 114. In an exemplary embodiment, the controller 14 uses computer vision and/or scene text recognition (STR) techniques to evaluate data from the plurality of vehicle sensors 16 and validate the predicted traffic sign. In another exemplary embodiment, to validate the predetermined traffic sign, the controller 14 evaluates the predicted traffic sign with predetermined ruleset. In a non-limiting example, the predetermined ruleset includes rules such as, for example, maximum speed limit=75 mph, minimum speed limit=15 mph, maximum speed limit for an urban roadway=45 mph, and/or the like. In a non-limiting example, the predetermined ruleset includes rules from traffic laws, rules, standards, and/or the like, such as, for example, rules from the Manual on Uniform Traffic Control Devices. If the predicted traffic sign is contrary to the predetermined ruleset, the method 100 proceeds to block 122. If the predicted traffic sign is not contrary to the predetermined ruleset, the method 100 proceeds to blocks 124 and 126.

At block 122, the controller 14 modifies the predicted traffic sign in response to determining that the predicted traffic sign is contrary to the predetermined ruleset at block 120. For example, if the predicted traffic sign is a speed limit sign indicating a speed limit of 80 mph, at block 122, the predicted traffic sign is modified to indicate a speed limit of 75 mph, according to the exemplary predetermined ruleset discussed above. After block 112, the method 100 proceeds to blocks 124 and 126.

At block 124, the controller 14 uses the vehicle communication system 28 to transmit the predicted traffic sign. In an exemplary embodiment, the predicted traffic sign is transmitted to a remote vehicle, using, for example, a V2V message. In another exemplary embodiment, the predicted traffic sign is transmitted to a remote server, such as, for example, an internet-connected map database containing traffic sign information. After block 124, the method 100 proceeds to enter a standby state at block 128.

At block 126, the controller 14 adjusts the path planning and control algorithm of the automated driving system 18 based at least in part on the predicted traffic sign. As discussed above, the path planning and control algorithm generates a sequence of waypoints or a continuous path that the vehicle 12 should follow to reach a destination based at least in part on traffic signs in the environment surrounding the vehicle 12. Therefore, upon determination and validation of the predicted traffic sign, the predicted traffic sign is communicated to the automated driving system 18 and the automated driving system 18 recalculates the path planning and control algorithm to account for the predicted traffic sign. After block 126, the method 100 proceeds to enter the standby state at block 128.

In an exemplary embodiment, the controller 14 repeatedly exits the standby state 128 and restarts the method 100 at block 102. In a non-limiting example, the controller 14 exits the standby state 128 and restarts the method 100 on a timer, for example, every three hundred milliseconds.

The system 10 and method 100 of the present disclosure offer several advantages. If traffic signs along a roadway are unable to be identified by the plurality of vehicle sensors 16, or sign recognition methods fail to detect and/or recognize sign messages, the system 10 and method 100 may be used to predict traffic signs, improving the performance of the automated driving system 18. Furthermore, dynamic roadway conditions such as, for example, construction, weather, traffic volume, and/or the like may render posted traffic signs and/or traffic sign information stored in map databases invalid or non-ideal. Therefore, the system 10 and method 100 may be used to predict traffic signs based on dynamic conditions. After predicting the traffic sign, the system 10 and method 100 may be used to transmit the predicted traffic sign to other vehicles and/or remote systems, allowing for crowd-sourcing of traffic sign predictions.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for traffic sign prediction, the method comprising:
determining a plurality of roadway characteristics;
determining a plurality of road user information;
determining a plurality of weather-related information;
determining a predicted traffic sign based at least in part on the plurality of roadway characteristics, the plurality of road user information, and the plurality of weather-related information; and
performing an action based at least in part on the predicted traffic sign.

2. The method of claim 1, wherein determining the plurality of roadway characteristics further comprises:
determining the plurality of roadway characteristics using at least one of: a perception sensor and data retrieved from a remote server, wherein the plurality of roadway characteristics includes at least one roadway geometry characteristic, at least one roadway condition characteristic, and at least one roadside environment characteristic.

3. The method of claim 1, wherein determining the plurality of road user information further comprises:
detecting a plurality of road users;
detecting a plurality of roadside users;
determining a plurality of predicted paths of each of the plurality of road users and the plurality of roadside users; and
determining the plurality of road user information, wherein the plurality of road user information includes at least a quantity of the plurality of road users, a quantity of the plurality of roadside users, and the plurality of predicted paths.

4. The method of claim 1, wherein determining the plurality of weather-related information further comprises:
determining the plurality of weather-related information using at least one of: a perception sensor and data retrieved from a remote server, wherein the plurality of weather-related information includes at least one precipitation weather condition and at least one visibility weather condition.

5. The method of claim 1, wherein determining the predicted traffic sign further comprises:
determining the predicted traffic sign using a rule-based algorithm, wherein the rule-based algorithm takes the plurality of roadway characteristics, the plurality of road user information, and the plurality of weather-related information as inputs and produces the predicted traffic sign as output.

6. The method of claim 1, wherein determining the predicted traffic sign further comprises:
determining the predicted traffic sign using a fuzzy logic algorithm, wherein the fuzzy logic algorithm takes the plurality of roadway characteristics, the plurality of road user information, and the plurality of weather-related information as inputs and produces a plurality of possible predicted traffic signs and a corresponding plurality of confidence values as output; and
determining the predicted traffic sign to be one of the plurality of possible predicted traffic signs based at least in part on the corresponding plurality of confidence values.

7. The method of claim 1, wherein determining the predicted traffic sign further comprises:
determining the predicted traffic sign using a machine learning algorithm, wherein the machine learning algorithm takes the plurality of roadway characteristics, the plurality of road user information, and the plurality of weather-related information as inputs and produces a plurality of possible predicted traffic signs and a corresponding plurality of confidence values as output; and
determining the predicted traffic sign to be one of the plurality of possible predicted traffic signs based at least in part on the corresponding plurality of confidence values.

8. The method of claim 1, wherein determining the predicted traffic sign further comprises:
validating the predicted traffic sign using a predetermined ruleset.

9. The method of claim 8, wherein validating the predicted traffic sign further comprises:
evaluating the predicted traffic sign with the predetermined ruleset; and
modifying the predicted traffic sign in response to determining that the predicted traffic sign is contrary to the predetermined ruleset.

10. The method of claim 1, wherein performing the action based at least in part on the predicted traffic sign further comprises:
transmitting the predicted traffic sign to at least one of: a remote vehicle and a remote server; and
adjusting a path planning and control algorithm of an automated driving system based at least in part on the predicted traffic sign.

11. A system for traffic sign prediction for a vehicle, the system comprising:
a plurality of vehicle sensors;
a controller in electrical communication with the plurality of vehicle sensors, wherein the controller is programmed to:
determine a plurality of roadway characteristics using at least one of the plurality of vehicle sensors;
determine a plurality of road user information using at least one of the plurality of vehicle sensors;
determine a plurality of weather-related information using at least one of the plurality of vehicle sensors;
determine a predicted traffic sign based at least in part on the plurality of roadway characteristics, the plurality of road user information, and the plurality of weather-related information; and
perform an action based at least in part on the predicted traffic sign.

12. The system of claim 11, wherein the plurality of vehicle sensors further includes at least one perception sensor, and wherein to determine the plurality of roadway characteristics, the controller is further programmed to:
perform a plurality of measurements of an environment surrounding the vehicle using the at least one perception sensor; and
determine the plurality of roadway characteristics based at least in part on the plurality of measurements, wherein the plurality of roadway characteristics includes at least one roadway geometry characteristic, at least one roadway condition characteristic, and at least one roadside environment characteristic.

13. The system of claim 11, wherein the plurality of vehicle sensors further includes a vehicle communication system, and wherein to determine the plurality of roadway characteristics, the controller is further programmed to:
receive at least one of: a V2V message and a V2X message including the plurality of roadway characteristics using the vehicle communication system, wherein the plurality of roadway characteristics includes at least one roadway geometry characteristic, at least one roadway condition characteristic, and at least one roadside environment characteristic.

14. The system of claim 11, wherein to determine the plurality of road user information, the controller is further programmed to:
detect a plurality of road users using the plurality of vehicle sensors;
detect a plurality of roadside users using the plurality of vehicle sensors;
determine a plurality of predicted paths of each of the plurality of road users and the plurality of roadside users; and
determine the plurality of road user information, wherein the plurality of road user information includes at least a quantity of the plurality of road users, a quantity of the plurality of roadside users, and the plurality of predicted paths.

15. The system of claim 11, wherein the plurality of vehicle sensors further includes at least one of a perception sensor and a vehicle communication system, and wherein to determine the plurality of weather-related information, the controller is further programmed to:
determine the plurality of weather-related information using at least one of: the perception sensor and the vehicle communication system, wherein the plurality of weather-related information includes at least one precipitation weather condition and at least one visibility weather condition.

16. The system of claim 11, wherein to determine the predicted traffic sign, the controller is further programmed to:
determine the predicted traffic sign using a prediction algorithm, wherein the prediction algorithm takes the plurality of roadway characteristics, the plurality of road user information, and the plurality of weather-related information as inputs and produces a plurality of possible predicted traffic signs and a corresponding plurality of confidence values as output, and wherein the prediction algorithm is at least one of: a rule-based algorithm, a fuzzy logic algorithm, and a machine learning algorithm;
determine the predicted traffic sign to be one of the plurality of possible predicted traffic signs based at least in part on the corresponding plurality of confidence values;
validate the predicted traffic sign by evaluating the predicted traffic sign with a predetermined ruleset; and
modify the predicted traffic sign in response to determining that the predicted traffic sign is contrary to the predetermined ruleset.

17. The system of claim 11, further comprising an automated driving system in electrical communication with the controller, wherein the plurality of vehicle sensors further includes a vehicle communication system, and wherein to perform the action, the controller is further programmed to:
transmit the predicted traffic sign to at least one of: a remote vehicle and a remote server using the vehicle communication system; and
adjust a path planning and control algorithm of the automated driving system based at least in part on the predicted traffic sign.

18. A system for traffic sign prediction for a vehicle, the system comprising:
a plurality of vehicle sensors, wherein the plurality of vehicle sensors includes at least one perception sensor, and wherein the plurality of vehicle sensors further includes at least a vehicle communication system;
an automated driving system;
a controller in electrical communication with the plurality of vehicle sensors and the automated driving system, wherein the controller is programmed to:
determine a plurality of roadway characteristics using at least one of the plurality of vehicle sensors, wherein the plurality of roadway characteristics includes at least one roadway geometry characteristic, at least one roadway condition characteristic, and at least one roadside environment characteristic;
determine a plurality of road user information using at least one of the plurality of vehicle sensors;
determine a plurality of weather-related information using at least one of the plurality of vehicle sensors, wherein the plurality of weather-related information includes at least one precipitation weather condition and at least one visibility weather condition;
determine a predicted traffic sign based at least in part on the plurality of roadway characteristics, the plurality of road user information, and the plurality of weather-related information;
transmit the predicted traffic sign to at least one of: a remote vehicle and a remote server using the vehicle communication system; and
adjust a path planning and control algorithm of the automated driving system based at least in part on the predicted traffic sign.

19. The system of claim 18, wherein to determine the plurality of road user information, the controller is further programmed to:
detect a plurality of road users using the plurality of vehicle sensors;
detect a plurality of roadside users using the plurality of vehicle sensors;
determine a plurality of predicted paths of each of the plurality of road users and the plurality of roadside users; and
determine the plurality of road user information, wherein the plurality of road user information includes at least a quantity of the plurality of road users, a quantity of the plurality of roadside users, and the plurality of predicted paths.

20. The system of claim 19, wherein to determine the predicted traffic sign, the controller is further programmed to:
determine the predicted traffic sign using a prediction algorithm, wherein the prediction algorithm takes the plurality of roadway characteristics, the plurality of road user information, and the plurality of weather-related information as inputs and produces a plurality of possible predicted traffic signs and a corresponding plurality of confidence values as output, and wherein the prediction algorithm is at least one of: a rule-based algorithm, a fuzzy logic algorithm, and a machine learning algorithm;
determine the predicted traffic sign to be one of the plurality of possible predicted traffic signs based at least in part on the corresponding plurality of confidence values;
validate the predicted traffic sign by evaluating the predicted traffic sign with a predetermined ruleset; and
modify the predicted traffic sign in response to determining that the predicted traffic sign is contrary to the predetermined ruleset.
